(19) United States
(12) Patent Application Publication
(10) Pub. No.: US 2015/0063173 A1
(43) Pub. Date: Mar. 5, 2015

(54) SYSTEM AND METHOD FOR CONNECTING TO A CONFERENCE CALL

(71) Applicant: BLACKBERRY LIMITED, Waterloo (CA)

(72) Inventors: Thaddeus Clark White, Mountain View, CA (US); Raymond Lee Canton, Ottawa (CA); Monica Zaczynski, Ottawa (CA); Remi Wesley Ogundokun, Ottawa (CA)

(73) Assignee: BLACKBERRY LIMITED, Waterloo (CA)

(21) Appl. No.: 14/015,963

(22) Filed: Aug. 30, 2013

(51) Int. Cl. H04L 29/06

(52) U.S. Cl. CPC H04L 65/403
USPC 370/261

(57) ABSTRACT

Methods and systems are disclosed for connecting an electronic device to a conference call. The method includes determining, at a conference server, whether the electronic device is VoIP-enabled. The method further includes, responsive to determining that the electronic device is VoIP-enabled, sending data to the electronic device for establishing connection to the conference call over VoIP communications; otherwise, sending data to the electronic device for establishing connection to the conference call over one of a public land mobile network (PLMN) or a public switched telephone network (PSTN).

### FIELD

The present disclosure generally relates to conferencing using electronic devices. Example embodiments herein relate to methods and systems for connecting electronic devices, and in particular, mobile devices to a conference call.

### BACKGROUND

An electronic device, such as a mobile device (for example, a cellular phone, a smartphone, a tablet, a netbook, a laptop, a PDA (personal digital assistant)), is often used for making conference calls when the user of the electronic device does not have other alternative communication ways, such as a landline telephone device, or when the user simply prefers to use the electronic device to make the conference call. Typically, to join the conference call at a scheduled conference time, a conference participant needs to, for example, unlock his or her mobile device, open a calendar or email application, find the appropriate meeting, open the meeting event to obtain the details of the meeting, dial the conference call phone number, enter an access code, and enter a participant's code. The whole process is time consuming and cumbersome because it requires many actions from the user of the mobile device. This is especially inconvenient when the user is driving or is in another situation that makes it difficult to complete this long series of actions.

### BRIEF DESCRIPTION OF THE DRAWINGS

Reference will now be made to the accompanying drawings showing example embodiments of this disclosure. In the drawings:

FIG. 1 shows, in block diagram form, an example system 100 for control and management of conference calls, consistent with embodiments of the present disclosure;

FIG. 2 is a block diagram illustrating an example mobile device 200, consistent with embodiments of the present disclosure;

FIG. 3 is a flowchart illustrating an example method for connecting a new participant to a conference call, consistent with example embodiments of the present disclosure; and

FIG. 4 is another example illustration of system 100, consistent with embodiments of the present disclosure.

### DESCRIPTION OF EXAMPLE EMBODIMENTS

Reference will now be made in detail to the example embodiments implemented according to the present disclosure, the examples of which are illustrated in the accompanying drawings.

Other aspects of the present disclosure will be apparent to those of ordinary skill in the art from a review of the following detailed description in conjunction with the drawings.

Embodiments of the present disclosure are not limited to any particular operating system, mobile device architecture, server architecture, or computer programming language.

The present disclosure relates to a conference call initiation. Although “call” or “calls” are referenced to in the description of example embodiments below, it will be appreciated that the described systems and methods are applicable to session-based communications in general and are not limited to voice calls. It will also be appreciated that the systems and methods are not limited to sessions and are applicable to messaging-based or packet-based communications. Conference calls can include exchange of as any combination of voice data, video data, text data, image data (e.g., presentation data), file data, or any other types of data.

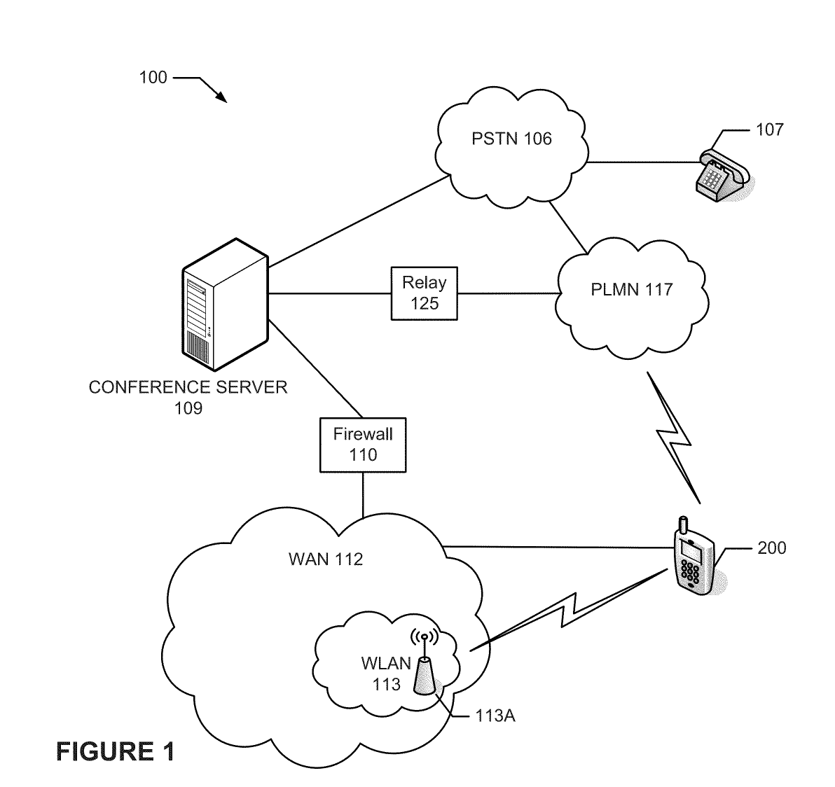

Reference is now made to FIG. 1, which shows, in block diagram form, an example system, generally designated as 100, for control and management of conference calls. System 100 includes a conference server 109, which in some embodiments can include more than one server and can be located in multiple geographic areas.

Conference server 109 can be connected, often through a firewall 110, to a wide area network (WAN) 112, such as the Internet. WAN 112 can be coupled to and accessed through either a wired connection or a wireless local area network (WLAN) 113 featuring a wireless access point 113A that operates, for example, in accordance with one of the IEEE 802.11 specifications.

Conference server 109 can also be connected to a public switched telephone network (PSTN) 106 via direct inward dialing (DID) trunks or primary rate interface (PRI) trunks. Conference server 109 can also communicate, often through a relay 125, with a public land mobile network (PLMN) 117, which can also be referred to as a wireless wide area network (WWAN) or a cellular network. In some cases, PLMN 117 can be interconnected with or integrated into PSTN 106.

System 100 can include a number of electronic devices, which can include mobile devices, such as a mobile device 200, and stationary devices, such as a telephone set 107. Mobile device 200 can be, for example, a cellular phone, a smartphone, a tablet, a netbook, a laptop, a PDA (personal digital assistant), or any other device enabled for wireless communication. Mobile device 200 can be equipped for cellular communications through PLMN 117, for communications over WAN 112 (accessed, for example, through WLAN 113 by connecting via Wi-Fi to wireless access point 113A) or it can be a dual-mode device capable of both cellular and WAN/WLAN communications. Cellular communications through PLMN 117 can include voice communications and data communications, and mobile device 200 can support either or both these communication channels.

Mobile device 200 can also include one or more radio transceivers and associated processing hardware and software to enable wireless communications with PLMN 117, and/or a WLAN 113 via wireless access points 113A. In various embodiments, PLMN 117 and mobile device 200 are configured to operate in compliance with any one or more of a number of wireless protocols, including GSM, GPRS, CDMA, EDGE, UMTS, EvDO, HSPA, 3GPP, LTE, or a variety of others. It will be appreciated that mobile device 200 can roam within PLMN 117 and across PLMNs, in a known manner, as its user moves. In some instances, dual-mode mobile device 200 and/or conference server 109 are configured to facilitate roaming between PLMN 117 and a wireless access points 113A, and are thus capable of seamlessly transferring sessions (such as voice calls) from a connection with the cellular interface of a dual-mode device (i.e., mobile device 200) to a WLAN interface of the dual-mode device, and vice versa. Mobile device 200 will be described in more detail below.

Relay 125 serves to direct communications received over PLMN 117 from mobile device 200 to conference server 109. Relay 125 also directs communications from conference server 109 to mobile device 200 via PLMN 117.

Telephone set 107 can be a conventional landline telephone that can communicate with conference server 109 through PSTN 106.

Conference server 109 can be implemented on one or more servers having suitable communications interfaces for connecting to and communicating with other system components. Conference server 109 can include one or more processors (not shown), a memory (not shown), and a data interface (not shown). The processor(s) can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), and MO (magneto-optical), a DVD-ROM (digital versatile disk-read only memory), a DVD RAM (digital versatile disk-random access memory), or a semiconductor memory.

In some embodiments, the memory stores user-profile information on one or more users. The user-profile information can include, for example, a user's name, email address, location data, place of employment, home address, or the like. In addition, the user-profile information can include device information for one or more electronic devices (e.g., one or more mobile devices 200 and/or one or more telephone sets 107) associated with a user. Device information can include device's phone number (e.g., a cellular phone number or a landline number), a personal identification number (PIN), an IP address, if available, and so forth. In some embodiments, some or all of the user-profile information, including device information, can be retrieved, by conference server 109, from the electronic devices. For example, if user-information for a particular electronic device includes device information only for one device associated with the user, and the device information includes only the IP address of the device, conference server 109 can use the IP information to communicate with the electronic device, for example, via WAN 112. Conference server can then retrieve from the electronic device additional device information for the device itself (e.g., a cellphone number associated with the device) and/or device information for other electronic devices associated with the same user (e.g., a landline number of the user's telephone set 107).

Conference server 109 implements the switching to connect session legs and provides the conversion between, for example, a circuit-switched call and a VoIP call, or to connect legs of other media sessions. In some embodiments, in the context of voice calls, conference server 109 provides a number of additional functions including automated attendant, interactive voice response, call forwarding, conference call, etc. It can also implement certain usage restrictions on enterprise users, such as blocking international calls or toll free calls. In many embodiments, Session Initiation Protocol (SIP) can be used to set-up, manage, and terminate media sessions for voice calls. Other protocols can also be employed by conference server 109, for example, Web Services, Computer Telephony Integration (CTI) protocol, Session Initiation Protocol for Instant Messaging and Presence Leveraging Extensions (SIMPLE), and various custom Application Programming Interfaces (APIs), as will be described in greater details below.

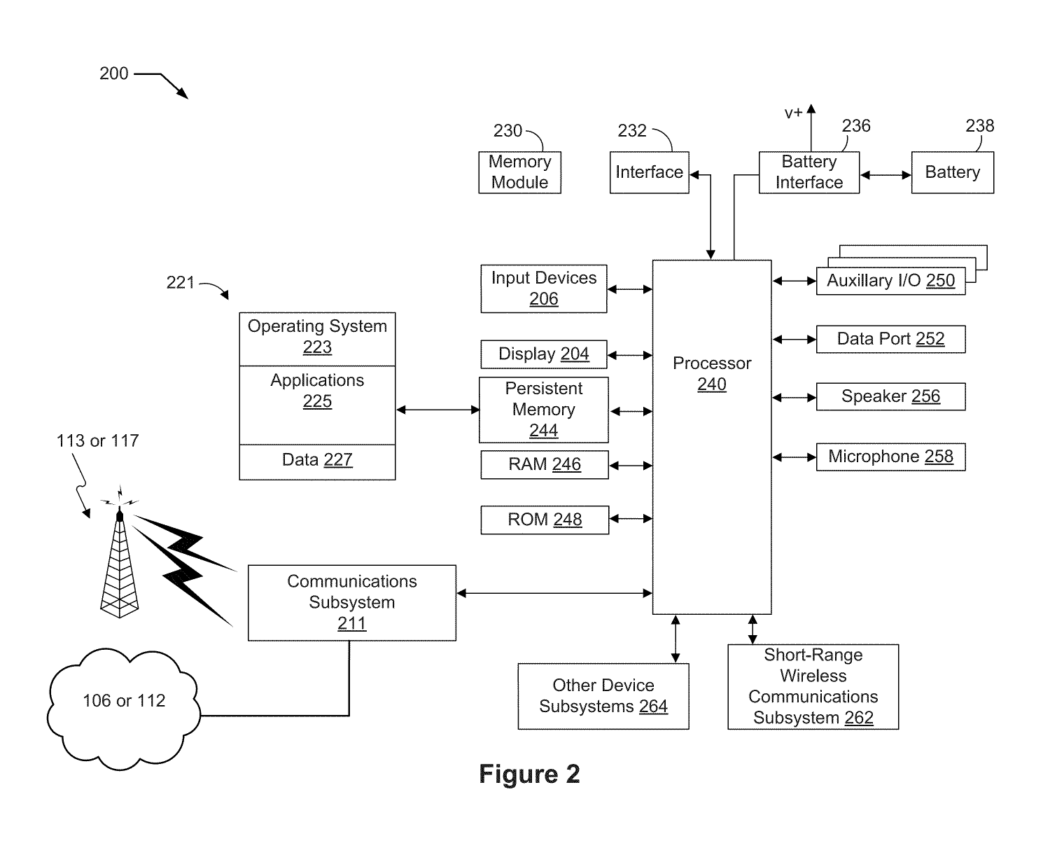

Reference is now made to FIG. 2, which illustrates an example embodiment for a mobile device 200. As depicted in FIG. 2, mobile device 200 is a two-way communication device having data and voice communication capabilities, and the capability to communicate with other computer systems.

Mobile device 200 includes a case (not shown) housing the components shown in FIG. 2. The internal components of mobile device 200 can, for example, be constructed on a printed circuit board (PCB). The description of mobile device 200 herein mentions a number of specific components and subsystems. Although these components and subsystems can be realized as discrete elements, the functions of the components and subsystems can also be realized by integrating, combining, or packaging one or more elements in any suitable fashion.

Mobile device 200 includes a controller comprising at least one processor 240 (such as a microprocessor), which controls the overall operation of mobile device 200. Processor 240 interacts with device subsystems such as a communications subsystem 211 for exchanging signals with the various networks (e.g., WLAN 113 and PLMN 117), to perform communication functions. Processor 240 interacts with additional device subsystems including a display 204, such as a liquid crystal display (LCD) or any other appropriate display; input devices 206 such as a keyboard and control buttons; persistent memory 244; random access memory (RAM) 246; read only memory (ROM) 248; auxiliary input/output (I/O) subsystems 250; data port 252 such as a conventional serial data port or a Universal Serial Bus (USB) data port; speaker 256; microphone 258; short-range wireless communications subsystem 262 (which can employ any appropriate wireless (e.g., RF), optical, or other short range communications technology); and other device subsystems generally designated as 264. Some of the subsystems shown in FIG. 2 perform communication-related functions, whereas other subsystems can provide “resident” or on-device functions.

Display 204 can be realized as a touch-screen display in some embodiments. The touch-screen display can be constructed using a touch-sensitive input surface connected to an electronic controller and which overlays the visible element of display 204. The touch-sensitive overlay and the electronic controller provide a touch-sensitive input device and processor 240 interacts with the touch-sensitive overlay via the electronic controller.

Communications subsystem 211 includes one or more communication systems for communicating with WAN 112 (e.g., via Wi-Fi through WLAN 113, or via a wired connection), and/or PLMN 117. The particular design of communications subsystem 211 depends on the network(s) in which mobile device 200 is intended to operate. Mobile device 200 can send and receive communication signals over the various networks after the required network registration or activation procedures have been completed.

Processor 240 operates under stored program control and executes software modules 221 stored in memory such as persistent memory 244 or ROM 248. Processor 240 can execute instructions. ROM 248 can contain data, program instructions, or both. Persistent memory 244 can contain data, program instructions, or both; in some embodiments is rewritable under control of processor 240; and can be realized using any appropriate persistent memory technology, including EEPROM, EAROM, FLASH, and the like. As illustrated in FIG. 2, software modules 221 can include operating system software 223. Additionally, software modules 221 can include software applications 225.

Software modules 221 or parts thereof can be temporarily loaded into volatile memory such as RAM 246. RAM 246 is used for storing runtime data variables and other types of data or information. In some embodiments, different assignment of functions to the types of memory could also be used.

Software applications 225 can further include a range of applications, including, for example, an application related to voice communication (i.e., telephony) application, e-mail application, address book, calendar application, notepad application, Internet browser application, mapping application, a media player application, and so forth.

Software applications can also include a messaging/teleconference application, such as BlackBerry messenger (BBM). The messaging/teleconference application allows the user to exchange text messages, files, images, video and/or audio recordings, contacts, or any other information with other users. The messaging/teleconference application can also allow the user to hold video and/or audio conference calls with other users. The other users can use either the same type of messaging/teleconference application (e.g., BBM), or any other application that supports messaging and/or teleconferencing and is capable of communicating with conference server 109.

Each of software applications 225 can include layout information defining the placement of particular fields and graphic elements (e.g., text fields, input fields, icons, etc.) in the user interface (i.e., display 204) according to the application.

In some embodiments, auxiliary input/output (I/O) subsystems 250 comprise an external communication link or interface, for example, an Ethernet connection capable of connecting mobile device 200 directly to WAN 112, bypassing WLAN 113. In some embodiments, auxiliary I/O subsystems 250 can further comprise one or more input devices, including a pointing or navigational tool such as a clickable trackball or scroll wheel or thumbwheel, or one or more output devices, including a mechanical transducer such as a vibrator for providing vibratory notifications in response to various events on mobile device 200 (for example, receipt of an electronic message or incoming phone call), or for other purposes such as haptic feedback (touch feedback).

In some embodiments, mobile device 200 also includes one or more removable memory modules 230 (typically comprising FLASH memory) and one or more memory module interfaces 232. Among possible functions of removable memory module 230 is to store information used to identify or authenticate a user or the user's account to wireless network (e.g., WLAN 113 and/or PLMN 117). For example, in conjunction with certain types of wireless networks, including GSM and successor networks, removable memory module 230 is referred to as a Subscriber Identity Module or SIM. Memory module 230 is inserted in or connected to memory module interface 232 of mobile device 200 in order to operate in conjunction with the wireless network.

Mobile device 200 stores data 227 in persistent memory 244. In various embodiments, data 227 includes service data comprising information required by mobile device 200 to establish and maintain communications with the wireless network (for example, WAN 112 and/or PLMN 120). For example, data 227 can include user-profile information, including unique device identifiers, such as a device personal identification number (PIN). Additionally, persistent memory 244 can store information relating to various people (contacts), for example, their names, usernames, email addresses, location data, home/cell/work phone numbers, home address, device PIN, and so forth.

In some embodiments, mobile device 200 also includes a battery 238, which furnishes energy for operating mobile device 200. Battery 238 can be coupled to the electrical circuitry of mobile device 200 through a battery interface 236, which can manage such functions as charging battery 238 from an external power source (not shown) and the distribution of energy to various loads within or connected to mobile device 200. Short-range wireless communications subsystem 262 is an additional optional component that provides for communications between mobile device 200 and different systems or devices, which need not necessarily be similar devices. For example, short-range wireless communications subsystem 262 can include an infrared device and associated circuits and components, or a wireless bus protocol compliant communication mechanism such as a Bluetooth communication module to provide for communications with similarly-enabled systems and devices.

A predetermined set of applications that control basic device operations, including data and voice communication applications can be installed on mobile device 200 during or after manufacture. Additional applications and/or upgrades to operating system software 223 or software applications 225 can also be loaded onto mobile device 200 through the networks (for example, WAN 112, WLAN 113, and/or PLMN 120), auxiliary I/O subsystem 250, data port 252, short-range wireless communications subsystem 262, or other suitable subsystem such as 264. The downloaded programs or code modules can be permanently installed, for example, written into the program memory (for example, persistent memory 244), or written into and executed from RAM 246 for execution by processor 240 at runtime.

As discussed above, a mobile device 200 may be capable of communicating with conference server 109 through one or more types of network, such as WAN 112 (directly or through WLAN 113), PLMN 117, PSTN 106, or other suitable networks.

Furthermore, PLMN 117 can support the transmittal of both voice communications and data communications, and users may be able to use only one (e.g., voice) or both of these channels of communication depending on their subscription plans with their mobile service providers. If a user is subscribed to a data plan, the user can access the Internet through the data channel of PLMN 117 (e.g., browse the Web, exchange emails, watch videos, etc.) similarly to accessing the Internet through WAN 112.

Even if mobile device 200 supports a particular type of network, it does not always have access to that network. For example, in order for a Wi-Fi-enabled mobile device 200 to connect to WAN 112 through WLAN 113, mobile device 200 must be located in an area with a sufficiently strong signal from at least one access point (e.g., access point 113A). Similarly, mobile device 200 capable of communicating via PLMN 117 using both voice and data communications can sometimes be denied usage of one or both of these capabilities if it is located outside of the coverage zone of a particular PLMN network (or networks) to which the device is subscribed, or if the signal is extremely weak.

A growing number of users today communicate using voice-over-internet-protocol (VoIP) applications. VoIP refers generally to the delivery of voice communications over the Internet Protocol (IP) and can therefore be implemented over any digital data network, such as WLAN, WAN, the data channel of PLMN 117, etc. VoIP can be implemented using a variety of standard protocols, including, but not limited to: H.323, Session Initiation Protocol (SIP), Real-time Transport Protocol (RTP), Skype protocol, and the like. VoIP can also be implemented using any proprietary protocol. In addition to delivering voice data, VoIP protocol can also deliver text, video, image or any type of data.

VoIP communications offer several benefits over the conventional voice networks such as PSTN 106 or voice-only PLMN 117. For example, VoIP communications are often either free of charge or significantly less expensive than communications over conventional voice networks, especially in the case of long-distance or international calls. In addition, audio quality of VoIP can be superior to that of conventional voice communications because VoIP does not have strict bandwidth limitations. VoIP, however, also has several disadvantages; for example, it is characterized by lower reliability (e.g., more dropped calls), higher latencies, and other problems related to packet-switched networks. Also, although data communications are usually less expensive than voice communications, sometimes they can be more expensive, for example, when the user is travelling abroad and is “roaming.” Because each type of network has its advantages and disadvantages depending on the circumstances, it would be advantageous for the users whose mobile devices support both types of networks to be able to choose which network to use for their voice communications.

For mobile device 200 to be “VoIP-enabled,” that is, for it to be able to conduct communications via VoIP, mobile device 200 must support digital data communications. As discussed above, data communications can be implemented, for example, through WAN 112 (directly or via WLAN 113), or through a data channel of PLMN 117. In addition to being capable of exchanging digital data over at least one of these networks, mobile device 200 must be successfully connected to at least one of these networks at a given time in order to be considered VoIP-enabled at that time. In other words, mobile device 200 is considered to be VoIP-enabled at a given time, if it is connected to, and is able to exchange digital data through, one of the above-mentioned networks at that time. In addition, in some embodiments, in order to be considered VoIP-enabled, additional requirements must be satisfied. For example, minimum bandwidth or maximum latency thresholds can be set, such that the device is only VoIP-enabled if it is connected to at least one network that supports digital data exchange at an average rate above the minimum bandwidth threshold and with an average latency below the maximum latency threshold.

As described above, conference server 109 manages and facilitates conference calls between electronic devices, including mobile devices and stationary devices. Conference call information, including the conference call's starting time, dial-in number, authentication information (e.g., a password), and participant information (names, email addresses, phone numbers, messenger IDs/usernames such as BBM PIN) can be stored, for example, in the memory of conference server 109.

In some embodiments, joining a conference call can be achieved in two ways. Users scheduled to participate in a conference call (hereinafter, “participants”) using their electronic devices (hereinafter, “participant devices”) can choose to join the conference call by following the dial-in instructions, for example, by calling a telephone number associated with the conference call, inputting authentication information, identifying themselves, etc. Because this process is time consuming, cumbersome, or even unlawful in some jurisdictions (for example when the user is driving), participants are provided with an option of being automatically connected by conference server 109 at a predefined time, as will be described below.

Participants that select the automatic-connection option can choose to be connected at the starting time of a meeting, or some (predefined) time after the conference call has started. For example, conference server 109 can initially attempt to connect a participant at the conference call starting time, but the participant can decline the connection and instead request to be automatically reconnected at a later time (e.g., in 15 minutes). This can be achieved by using a “snooze” feature, which is described, for example, in application Ser. No. ______ (Attorney Docket No. 11298.0434-00000), which is hereby incorporated by reference. In those embodiments where the snooze button has been selected, the participant device can provide information indicating that the call was snoozed and the snooze time period to conference call server 109. On or after the snooze time period has elapsed, conference call server 109 can attempt to establish a connection with the participant device, as further described below.

In some embodiments, conference server 109 can also receive a real-time request to add a new participant, whether or not that participant was initially scheduled to be on the conference call. The request can originate, for example, from another conference call participant, such as the conference call's moderator or host, or from the new participant.

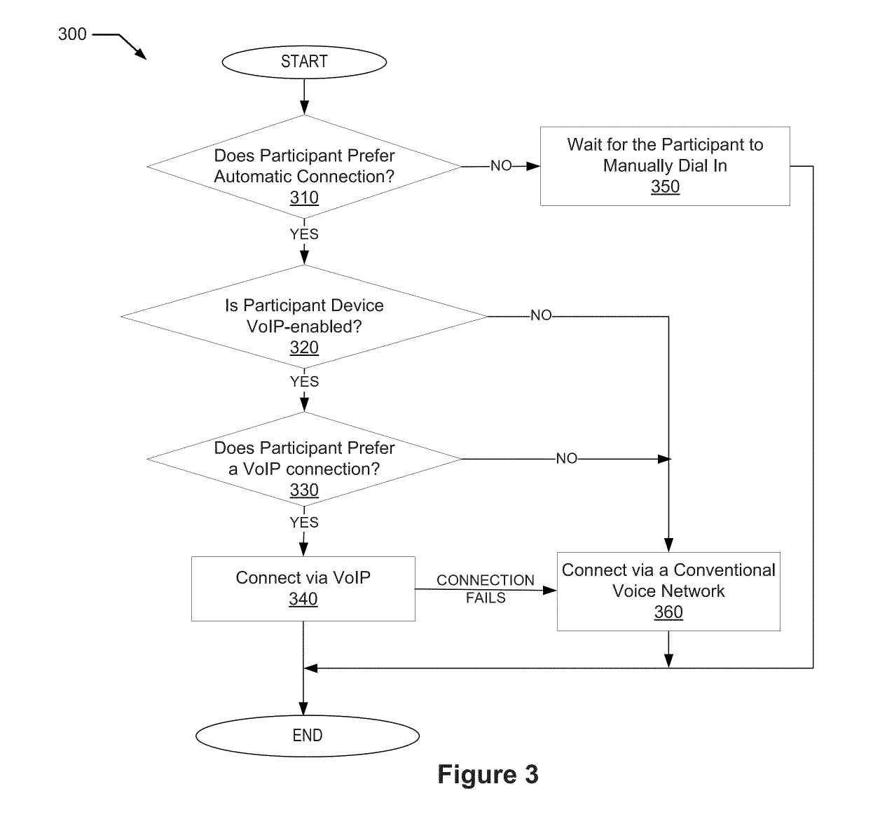

Whenever conference server 109 determines that a new participant needs to be added to the conference call, conference server 109 can perform a method 300 for connecting a new participant to the conference call. Method 300 is illustrated by a flowchart in FIG. 3, in accordance with some embodiments. It will be readily appreciated that the illustrated method can be altered to reorder steps, delete steps, or further include additional steps.

Method 300 begins at step 310, when a conference server (e.g., conference server 109) determines whether the participant prefers to be automatically added by conference server or whether the participant prefers to “manually” dial in. This connectivity preference is one of many user preferences that can be stored, for example, in the memory of the conference server. User preferences can initially be set to default values, and can later be modified by the user. The users can view and modify their preferences, for example, through a client application (running on a participant device), such as a BBM application. The application can display the current preferences to the user, receive modification requests from the user, and automatically send the modified preferences to the conference server, which can update the user preferences stored in its memory, accordingly.

In some embodiments, a user can specify in the user preferences that he would like to be automatically connected to all (or to none) of the conference calls. In other embodiments, a user can specify in the user preferences that he would like to be automatically connected to some conference calls, but to manually dial into other conference calls. For example, the user can identify a particular conference call to which that user would like to be automatically connected, and request not to be automatically connected to any other calls. As another example, the user may specify only particular dates, days of the week, and/or times of the day, at which he would prefer to be automatically connected. As stated above, the user preferences can be provided to the conference server, which can update the user preferences stored in its memory, accordingly.

Thus, at step 310, the conference server determines, based on the user preferences, whether this particular user prefers to be automatically connected to all conference calls or at least this particular conference call. It will be appreciated that in some embodiments step 310 can be omitted and the conference server will try to automatically connect all users to all conference calls.

If the conference server determines, at step 310, that the participant does not wish to be automatically connected to the conference call, the conference server does nothing and simply waits, at step 350, for the participant to manually dial into the conference call.

If, however, the conference server determines, at step 310, that the participant wishes to be automatically connected to the conference call, the conference server proceeds to determine, at step 320, whether the participant device is VoIP-enabled. In some embodiments, to determine whether the participant device is VoIP-enabled, conference server 109 accesses a database of known devices, such as a database of all devices running the BBM application. The database can be stored on the conference server, or it can be stored and accessed remotely. The database can indicate, for example, whether a particular device is VoIP-enabled at any given time.

The database can be periodically or randomly updated to reflect the VoIP-enabled status of the devices. For example, when a user runs a BBM application on a mobile device (e.g., mobile device 200), the application can gauge the device's networking capabilities, and based on those capabilities determine whether or not the mobile device is VoIP-enabled. The application can determine that the mobile device is VoIP-enabled, for example, when the mobile device supports digital data connection (e.g., through WLAN 113 and/or through the data channel of PLMN 117), that such connection is in fact available (i.e., the mobile device is in fact connected to at least one of these digital-data networks) and, optionally, that the bandwidth and/or latency of that digital data connection are sufficient to maintain a quality VoIP communication (e.g., the bandwidth is above a predefined minimum bandwidth threshold and the latency is below a maximum latency threshold). The application can then communicate this information to the conference server, which updates the database entry for the mobile device accordingly. In some embodiments, the database can be stored on a server remote to the conference server, and the application can access and update that database directly. The application can periodically re-test the network conditions, and update the database whenever the participant device becomes VoIP-enabled or not VoIP-enabled (VoIP-disabled).

In other embodiments, instead of checking a database, the conference server can request VoIP status information from the participant device directly. For example, if the participant device is running a BBM application, the conference server can communicate with the BBM application, inquiring whether the participant device is presently VoIP-enabled. The application can then check network conditions and, based on these one or more conditions, determine whether the participant device is VoIP-enabled or not, and report this determination to the conference server.

In addition to determining whether the participant device is VoIP-enabled or not, the conference server can determine, at step 320, which particular network or networks are presently available to the participant device. For example, after determining that the participant device is VoIP-enabled, the conference server can further check whether the participant device presently supports VoIP over WAN/WLAN only, over PLMN only, or over both. Also, the conference server can determine the bandwidth and the latency parameters associated with each available network. The network type and parameters can be communicated to the conference server by the participant device, similarly to above-described manners in which the participant device's VoIP-enabled/disabled status can be communicated.

If the conference server determines, at step 320, that the participant device is VoIP-enabled, the conference server proceeds to determine, at step 330, whether the participant device prefers to be connected to via VoIP or a conventional voice network. As discussed above, even though VoIP has many advantages over a conventional voice communication, in some situations, such as during roaming or unreliable or high-latency network conditions, the user may prefer to use the conventional voice network even when VoIP is available. Therefore, in some embodiments, as one of the user preferences, the user can set a preference regarding whether and when the conference server should use VoIP (if available) or a conventional voice network when it attempts to automatically connect the mobile device to the conference call.

For example, the user can set a preference to be connected via VoIP whenever VoIP is available, that is, whenever the conference server determines, at step 320, that the device is VoIP-enabled. As another example, the user can prefer to be connected via VoIP through the WLAN if the device is connected to the WLAN, but to never be connected through the data channel of the PLMN, even if that channel is available. In such a situation, the user may choose this option if his data plan is limited to a certain amount of data per month and the user is close to exceeding the monthly limit. As yet another example, the user can prefer to be connected via VoIP using any means, but never through the data channel of the PLMN when the mobile device is “roaming.” As yet another example, the user can request to always be connected via VoIP, except for a specific conference call, identified, for example, by its title, time and date, and/or conference-call ID.

In other words, the user can indicate in the user preferences a set of one or more predefined conditions that need to be satisfied in order for the conference server to connect the user through VoIP and not through a conventional voice network, or vice versa. The predefined conditions can include: predefined type(s) of network(s), predefined network parameter(s) (e.g., bandwidth, latency), predefined date(s) and time(s), predefined day(s) of the week, predefined geographic location(s), specific conference call(s), specific other participants on the call, or any other relevant conditions. If the conference server examines each of the approved conditions and determines, at step 330, that all the conditions are satisfied, it proceeds to step 340.

At step 340, the conference server attempts to establish a VoIP connection with the participant device. For example, if the participant device is a mobile device running a BBM application, the conference server can connect to (or “call”) the BBM application. If the connection is successfully initiated (or established), the mobile device can display on display (e.g., display 240) an incoming connection (call) from the conference server. In some embodiments, the mobile device presents to user (e.g., on display 240) information identifying the call, such as the title (subject) of the conference call, the name of the participants already joined and/or expected to join, the name of the organizer or the moderator, the dial-in phone number of the conference, or any other relevant information.

Upon displaying the incoming connection, the mobile device can receive an input selecting one of accepting the call (e.g., by touching a button “Accept” or “Join” on a touch screen display 204 or via input devices 206); rejecting the call (e.g., by touching a button “Reject” or “Refuse”), snoozing the call (e.g., by touching a “Snooze” button and optionally selecting the snooze time period, after which the conference server can try to reconnect), or performing other applicable actions. In those embodiments where the snooze button has been selected, the conference call server can attempt to establish a connection with the mobile device on or after the snooze time period has elapsed. As shown above, the mobile device can establish a connection with the conference server (i.e., joining the conference call) by performing minimal actions and in accordance with the user's preferences.

If the conference server determines, at step 320, that the participant device is not VoIP-enabled, or if it determines, at step 330, that the participant associated with the participant device prefers not to connect via VoIP (at least not to the present conference call session), the conference server proceeds to step 360, where it tries to establish a connection (call) with the participant device via a conventional voice network.

In some embodiments, the conference server can also proceed to step 360 from step 340, for example, when at step 340 the conference server tries to connect to the participant device via VoIP, but either the connection fails, or the user rejects the connection, requesting to be reconnected via a conventional voice network.

At step 360, the conference server attempts to establish a conventional voice connection with the participant device. In some embodiments, the conference server places a regular phone call to the phone number associated with the participant device. The phone number can be retrieved, for example, from the device information included in the user-profile information, as discussed above. The phone call can be routed, for example, through the PLMN if the participant device is a mobile device (e.g., mobile device 200), or through the PSTN if the participant device is a telephone set (e.g., telephone set 107). The call will be received by the participant device, for example, through its default phone-call application. The phone call can be identified by a caller-id, indicating, for example, the dial-in number of the conference call. Upon answering the phone call, the user will be automatically joined by conference server 109 to the conference call.

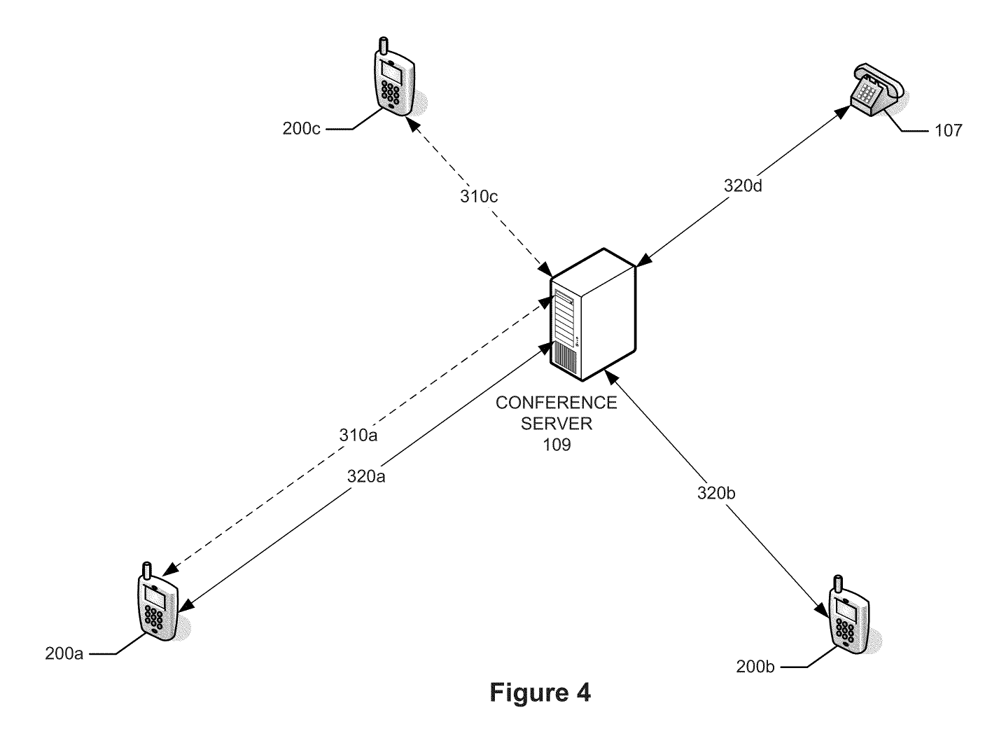

Method 300 is further illustrated with reference to FIG. 4, which depicts system 100, in accordance with an example embodiment. As illustrated in FIG. 4, system 100 includes conference server 109, mobile devices 200a, 200b, and 200c, and telephone set 107. Other system components, such as WAN 112, PLMN 117, and PSTN 106, were omitted for brevity.

In this example, telephone set 107 can communicate with conference server 109 via conventional voice communication (e.g., via PSTN 106) only, as indicated by a solid line 320d. Similarly, mobile device 200b can communicate with conference server 109 via conventional voice communication (e.g., via voice channel of PLMN 117) only, as indicated by a solid line 320b. Data channel of PLMN 117 may be unavailable for mobile device 200b, for example, because its subscription plan is limited to voice communications only, because the user manually disabled data communications on mobile device 200b, or for a variety of other reasons.

Mobile device 200c can communicate with conference server 109 via data communications only (e.g., via data channel of PLMN 117 or via WAN 112 through WLAN 113), as indicated by a dashed line 310c. Voice channel of PLMN 117 may be unavailable for mobile device 200c, for example, if mobile device 200c cannot be connected to PSTN 106 or PLMN 117 either because it lacks the physical capabilities (e.g., mobile device 200c can be a laptop computer), or it may have such capabilities but it may be located outside of PSTN 106 and PLMN 117 coverage zones. Nevertheless, mobile device 200c can exchange digital data, for example, through WAN 112 via WLAN 113.

Mobile device 200a can communicate with conference server 109 via both data and voice communications, as indicated by a dashed line 310a and a solid line 320a, respectively.

In this example, conference server 109 performing method 300 will first determine, at step 310, whether the user of each participant device prefers to be automatically connected to the conference call by conference server 109. As discussed above, conference server 109 can determine this by accessing the user preferences for each participant device. In this example, it will be assumed that all four participants have set their preferences to indicate that they would like to be automatically connected to the conference call.

Accordingly, conference call 109 will proceed to step 320 where it will determine, for each participant device, whether that device is VoIP-enabled. For mobile device 200b and for telephone set 107, it will determine that the devices are not VoIP-enabled because they do not support digital data communications, and conference server 109 will proceed to step 360. At step 360, conference server 109 will connect (call) mobile device 200b and telephone set 107 via a conventional voice network, for example, via the voice channel of PLMN 117 and via PSTN 106, respectively.

For mobile devices 200a and 200c, conference server 109 will determine that the devices are VoIP-enabled, assuming, in this example, that they are within range of their digital data networks (e.g., WAN 112 via WLAN 113 or data channel of PLMN 117). As described above, this determination can be performed in a number of ways, including accessing a database or contacting the participant devices directly, requesting their VoIP status and receiving from the participant devices information indicating whether they are VoIP-enabled.

Next, at step 330, conference server 109 will determine whether the users of devices 200a and 200c prefer to connect to the conference call over VoIP or over a conventional voice network. As described above, conference server 109 can check users' preferences for any predefined conditions under which the users prefer to connect over VoIP, and if conference server 109 determines that the predefined conditions are satisfied, it will proceed to connect the participant device(s) over VoIP at step 340. Otherwise, it will proceed to connect the participant device(s) over a conventional voice network at step 360. As noted above, in some embodiments, if at step 340 the VoIP connection fails, or at the user's request, conference server 109 can proceed to step 360 where it will try to establish a connection over a conventional voice network.

As illustrated in this example, some participant devices, such as mobile device 200c, cannot support communications over conventional voice networks. Therefore, in some embodiments, conference server 109, upon getting to step 360 can further determine (step not shown) whether the participant device supports conventional voice communications, and if not, either go to step 340 and try connecting to it over VoIP, or, if has already performed step 340, conference server 109 can proceed to the end of method 300 without connecting the participant device.

The methods disclosed herein can be implemented as a computer program product comprising computer-readable instructions. Computer-readable instructions can be stored on a tangible non-transitory computer-readable medium, such as a flexible disk, a hard disk, a CD-ROM (compact disk-read only memory), an MO (magneto-optical) disk, DVD-ROM (digital versatile disk-read only memory), a DVD RAM (digital versatile disk-random access memory), or a semiconductor memory. Alternatively, the methods can be implemented in hardware components or combinations of hardware and software of a data processing apparatus associated with the conference server, e.g. a programmable processor, a computer, or multiple computers. The computer program can be written in any form of programming language, including compiled or interpreted languages, and it can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A method for connecting an electronic device to a conference call, the method comprising:
determining, at a conference server, whether the electronic device is VoIP-enabled; and
responsive to determining that the electronic device is VoIP-enabled, sending data to the electronic device for establishing connection to the conference call over VoIP communications;
otherwise, sending data to the electronic device for establishing connection to the conference call over one of a public land mobile network (PLMN) or a public switched telephone network (PSTN).

2. The method of claim 1, further comprising:
determining, based on user preferences associated with the electronic device, whether VoIP communications are preferred communications type; and
responsive to determining that the VoIP communications are not the preferred communications type, sending data to the electronic device for establishing the connection to the conference call over one of PLMN or PSTN.

3. The method of claim 2, wherein the user preferences comprise a set of one or more predefined communication network types, and wherein determining whether the VoIP communications are the preferred communications type comprises determining whether the electronic device is connected to at least one of the set of predefined communication networks.

4. The method of claim 1, wherein determining whether the electronic device is VoIP-enabled comprises accessing a database comprising information indicating whether the electronic device is presently VoIP-enabled.

5. The method of claim 1, wherein determining whether the electronic device is VoIP-enabled comprises sending a query to the electronic device and receiving, from the electronic device, information indicating whether the electronic device is presently VoIP-enabled.

6. The method of claim 1, further comprising:
sending data to the electronic device for establishing the connection to the conference call over one of PLMN or PSTN if, after sending data to the electronic device for establishing the connection to the conference call over VoIP communications, the connection to the conference call over VoIP communications fails.

7. The method of claim 1, further comprising:
sending data to the electronic device for establishing the connection to the conference call over VoIP communications if, after sending data to the electronic device for establishing the connection to the conference call over one of PLMN or PSTN, the connection to the conference call over one of PLMN or PSTN fails.

8. The method of claim 1, wherein sending data to the electronic device for establishing the connection to the conference call over VoIP communications and sending data to the electronic device for establishing a connection to the conference call over one of PLMN or PSTN is performed by the conference server at a predefined time, wherein the predefined time is one of a starting time associated with the conference call and a snoozed time, wherein the snoozed time is later than the starting time by a defined period.

9. A conference server comprising:
one or more computer-readable storage media configured to store instructions; and
one or more processors configured to execute the instructions causing the conference server to:
determine whether the electronic is VoIP-enabled; and
responsive to determining that the electronic device is VoIP-enabled, send data to the electronic device for establishing connection to the conference call over VoIP communications; otherwise, send data to the electronic device for establishing connection to the conference call over one of a public land mobile network (PLMN) or a public switched telephone network (PSTN).

10. The conference server of claim 9, wherein the one or more processors are further configured to:
determine, based on user preferences associated with the electronic device, whether VoIP communications are preferred communications type; and
responsive to the determination that the VoIP communications are not the preferred communications type, send data to the electronic device for establishing the connection to the conference call over one of PLMN or PSTN.

11. The conference server of claim 10, wherein the user preferences comprise a set of one or more predefined communication network types, and wherein the determination whether the VoIP communications are the preferred communications type comprises a determination whether the electronic device is connected to at least one of the set of predefined communication networks.

12. The conference server of claim 9, wherein the determination whether the electronic device is VoIP-enabled comprises an access to a database comprising information indicating whether the electronic device is presently VoIP-enabled.

13. The conference server of claim 9, wherein the determination whether the electronic device is VoIP-enabled comprises a sending of a query to the electronic device and a receiving of information indicating whether the electronic device is presently VoIP-enabled.

14. The conference server of claim 9, wherein the one or more processors are further configured to:
send data to the electronic device for establishing the connection to the conference call over one of PLMN or PSTN if, after the sending of data to the electronic device for establishing the connection to the conference call over VoIP communications, the connection to the conference call over VoIP communications fails.

15. The conference server of claim 9, wherein the one or more processors are further configured to:
send data to the electronic device for establishing the connection to the conference call over VoIP communications if, after the sending of data to the electronic device for establishing the connection to the conference call over one of PLMN or PSTN, the connection to the conference call over one of PLMN or PSTN fails.

16. The conference server of claim 9, wherein the sending of data to the electronic device for establishing the connection to the conference call over VoIP communications and the sending of data to the electronic device for establishing a connection to the conference call over one of PLMN or PSTN is performed at a predefined time, wherein the predefined time is one of a starting time associated with the conference call and a snoozed time, wherein the snoozed time is later than the starting time by a defined period.

17. A non-transitory computer-readable medium storing a set of instructions that are executable by at least one processor of a conference server to cause the conference server to perform a method, the method comprising:
determining, at a conference server, whether the electronic device is VoIP-enabled; and
responsive to determining that the electronic device is VoIP-enabled, sending data to the electronic device for establishing connection to the conference call over VoIP communications;
otherwise, sending data to the electronic device for establishing connection to the conference call over one of a public land mobile network (PLMN) or a public switched telephone network (PSTN).

18. The non-transitory computer-readable medium of claim 17, further comprising instructions executable by the at least one processor of the conference server to cause the conference server to perform:
determining, based on user preferences associated with the electronic device, whether VoIP communications are preferred communications type; and
responsive to determining that the VoIP communications are not the preferred communications type, sending data to the electronic device for establishing the connection to the conference call over one of PLMN or PSTN.

19. The non-transitory computer-readable medium of claim 18, wherein the user preferences comprise a set of one or more predefined communication network types, and wherein determining whether the VoIP communications are the preferred communications type comprises determining whether the electronic device is connected to at least one of the set of predefined communication networks.

20. The non-transitory computer-readable medium of claim 17, wherein sending data to the electronic device for establishing the connection to the conference call over VoIP communications and sending data to the electronic device for establishing a connection to the conference call over one of PLMN or PSTN is performed by the conference server at a predefined time, wherein the predefined time is one of a starting time associated with the conference call and a snoozed time, wherein the snoozed time is later than the starting time by a defined period.
